(19) United States
(12) Patent Application Publication
(10) Pub. No.: US 2024/0338041 A1
(43) Pub. Date: Oct. 10, 2024

(54) UNMANNED AERIAL VEHICLE AERIAL SURVEY METHOD, DEVICE, AND SYSTEM FOR RIBBON-SHAPED TARGET AND STORAGE MEDIUM

(71) Applicant: SZ DJI TECHNOLOGY CO., LTD., Shenzhen (CN)

(72) Inventors: Zhihua YANG, Shenzhen (CN); Jiabin LIANG, Shenzhen (CN); Minglei ZHANG, Shenzhen (CN)

(73) Assignee: SZ DJI TECHNOLOGY CO., LTD., Shenzhen (CN)

(21) Appl. No.: 18/749,651

(22) Filed: Jun. 21, 2024

Related U.S. Application Data
(63) Continuation of application No. PCT/CN2021/140129, filed on Dec. 21, 2021.

(51) Int. Cl. G05D 1/689; G08G 5/00

(52) U.S. Cl. CPC G05D 1/689; G08G 5/003

(57) ABSTRACT

A method of route planning may include obtaining positional information of an target; based on the positional information of the target, planning a photographing route for photographing the target, the photographing route comprising a first route and a second route, an extension direction of the first route and an extension direction of the second route being substantially same as an extension direction of the target; and controlling a photographing device comprising a photosensitive structure photograph a first image at a first photographing waypoint in the first route and a second image at a second photographing waypoint in the second route. A first orientation of projection of the photosensitive structure corresponding to the first image on a horizontal plane is different from a second orientation of projection of the photosensitive structure corresponding to the second image on the horizontal plane.

### CROSS-REFERENCE TO RELATED APPLICATION

The present invention is a continuation of International Application No. PCT/CN2021/140129, filed Dec. 21, 2021, the entire contents of which being incorporated herein by reference in its entirety.

### TECHNICAL FIELD

The present invention relates to the technical field of unmanned aerial vehicle route planning, and more specifically, to a method, device, system and storage medium for unmanned aerial vehicle aerial survey of a ribbon target.

### BACKGROUND

Unmanned Aerial Vehicles (UAVs) are operated using radio remote control apparatuses and self-contained programmed controls, or are operated fully or intermittently autonomously by on-board computers. UAVs are widely used in aerial photography, surveying and mapping, agricultural plant protection, courier transportation, disaster relief, wildlife observation, monitoring of infectious diseases, news reporting, electric power inspection, disaster relief, or film and television photographing among many other fields.

In the field of UAV mapping, one of the needs is to map ribbon targets such as rivers, roads, railroad tracks, oil pipelines, or gas pipelines, which are usually long in length and narrow in width, and the mapping of these ribbon targets is of great significance for observing the health of the ribbon targets, discovering hidden dangers in vicinity of the ribbon targets, and deploying resources.

However, the existing UAV aerial survey method for ribbon targets such as rivers, roads, railroad tracks, oil pipelines, or natural gas pipelines have problems such as long range, low aerial survey efficiency, and heavy workload for image acquisition.

### SUMMARY

In view of this, one of the objects of the present invention is to provide a method, apparatus, system and storage medium for UAV aerial survey of a ribbon target.

In a first aspect, some embodiments of the present invention provide a method of route planning. The method may include obtaining positional information of an target; and, based on the positional information of the target, planning a photographing route for photographing the target, the photographing route comprising a first route and a second route, an extension direction of the first route and an extension direction of the second route being substantially same as an extension direction of the target, and a length of the first route being shorter than a length of the second route.

The first route comprises a first photographing waypoint, the second route comprises a second photographing waypoint, a photographing device comprising a photosensitive element photographs a first image at the first photographing waypoint and a second image at the second photographing waypoint, and an orientation of projection of the photosensitive element of the photographing device corresponding to the first image on a horizontal plane is different from an orientation of projection of the photosensitive element corresponding to the second image on the horizontal plane.

In a second aspect, some embodiments of the present invention provide a route planning device. The route planning device may include at least one processor; and at least one memory including computer program code, where the at least one memory and the computer program code are configured, with the at least one processor, to cause the route planning device to at least obtain positional information of an target; and based on the positional information of the target, plan a photographing route for photographing the target, the photographing route comprising a first route and a second route, an extension direction of the first route and an extension direction of the second route being substantially same as an extension direction of the target, and a length of the first route being shorter than a length of the second route.

The first route comprises a first photographing waypoint, the second route comprises a second photographing waypoint, a photographing device comprising a photosensitive element photographs a first image at the first photographing waypoint and a second image at the second photographing waypoint, and an orientation of projection of the photosensitive element of the photographing device corresponding to the first image on a horizontal plane is different from an orientation of projection of the photosensitive element corresponding to the second image on the horizontal plane.

In a third aspect, some embodiments of the present invention provide an aerial survey system comprising a UAV and the route planning device described in the second aspect;

The route planning device may be used to send to the UAV a planned and obtained photographing route for photographing a ribbon target.

The UAV may be used to fly in accordance with the photographing route and during the flight to capture a first image at a first photographing waypoint of the first route and a second image at a second photographing waypoint of the second route using the photographing device.

In a fourth aspect, some embodiments of the present invention provide a computer-readable storage medium, the computer-readable storage medium storing executable instructions, the executable instructions being executed by a processor to implement the method described in the first aspect.

It should be understood that the above general description and the detailed description that follows are exemplary and explanatory only and do not limit the present invention.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a schematic diagram of a photographing route in the related art;

FIG. 2 is a schematic diagram of a photographing route according to one embodiment of the present invention;

FIG. 3 is a schematic diagram of a structure of a photographing device according to an embodiment of the present invention;

FIG. 4 is a schematic diagram of an unmanned aerial system according to one embodiment of the present invention;

FIG. 5 is a flowchart of a UAV aerial survey method of a ribbon-shaped target according to an embodiment of the present invention;

FIG. 6 is a map that includes a ribbon-shaped target such as a river according to an embodiment of the present invention;

FIG. 7A is a schematic diagram of a photographing route according to an embodiment of the present invention;

FIG. 7B is a schematic diagram of another photographing route according to an embodiment of the present invention;

FIG. 8A is a schematic diagram of solving an image principal point image position in a case where an orientation of projection of the photosensitive element corresponding to each of three images on the horizontal plane is the same according to one embodiment of the present invention;

FIG. 8B is a schematic diagram of solving the image principal point image position in a case where an orientation of projection of the photosensitive element corresponding to each of three images on the horizontal plane is different according to one embodiment of the present invention;

FIG. 9A is a schematic diagram of solving a focal length in a case where an orientation of an photographing device corresponding to each of three images is the same as the direction of gravity according to one embodiment of the present invention;

FIG. 9B is a schematic diagram of solving a focal length in a case where an orientation of an photographing device corresponding to each of three images is different from the direction of gravity according to one embodiment of the present invention;

FIG. 10A is a schematic diagram of a photographing device at first waypoints in a first route facing to the right side relative to the direction of gravity according to one embodiment of the present invention;

FIG. 10B is a schematic diagram of a photographing device at second waypoints in a second route facing to the left side with respect to the direction of gravity according to one embodiment of the present invention;

FIG. 11 is a schematic illustration of an angle value between the orientation of the photographing device and the direction of gravity becoming first smaller and then larger when the UAV is flying along the first route according to one embodiment of the present invention;

FIG. 12 is a schematic diagram of a second route comprising a first sub-route and a second sub-route according to one embodiment of the present invention;

FIG. 13 is a schematic diagram of a structure of an aerial survey device according to one embodiment of the present invention.

### DETAILED DESCRIPTION

In order to make the purpose, technical solutions and advantages of the present disclosure clearer, the technical solutions of the present disclosure will be described clearly and completely in the following in conjunction with the accompanying drawings of the embodiments of the present disclosure. Obviously, the described embodiment is one embodiment of the present disclosure and not all of the embodiments. Based on the described embodiment of the present disclosure, all other embodiments obtained by a person of ordinary skill in the art without the need for creative labor fall within the scope of protection of the present disclosure.

Ribbon-shaped targets such as rivers, roads, railroad tracks, oil pipelines or gas pipelines are usually tens of kilometers in length and tens of meters in width. Some embodiments of the present invention provide UAV aerial survey methods for such ribbon targets. It should be noted that the photographing device can be carried on any movable platform, the movable platform includes a UAV or a aircraft or a robot.

Referring to FIG. 1, FIG. 1 illustrates a photographing route 01 for a ribbon-shaped target in the related art, the photographing route 01 being a “bow-shaped” route. The “bow-shaped” route includes a first route parallel to the ribbon-shaped target and a second route perpendicular to the ribbon target, and because the second routes perpendicular to the ribbon-shaped target need to satisfy a predetermined side-to-side overlap rate, the spacing between the two neighboring second routes is shorter, resulting in the “bow-shaped” route having a longer voyage; and in the case where the voyage of the “bow-shaped” route is long, the number of waypoints 02 at which images need to be captured increases, the workload of image acquisition is large, and the amount of data processing for the images is large; and as can be seen in FIG. 1, in the process of aerial photography by the UAV along the “bow-shaped” route, the heading direction of the UAV needs to be adjusted frequently, which also leads to low flight efficiency.

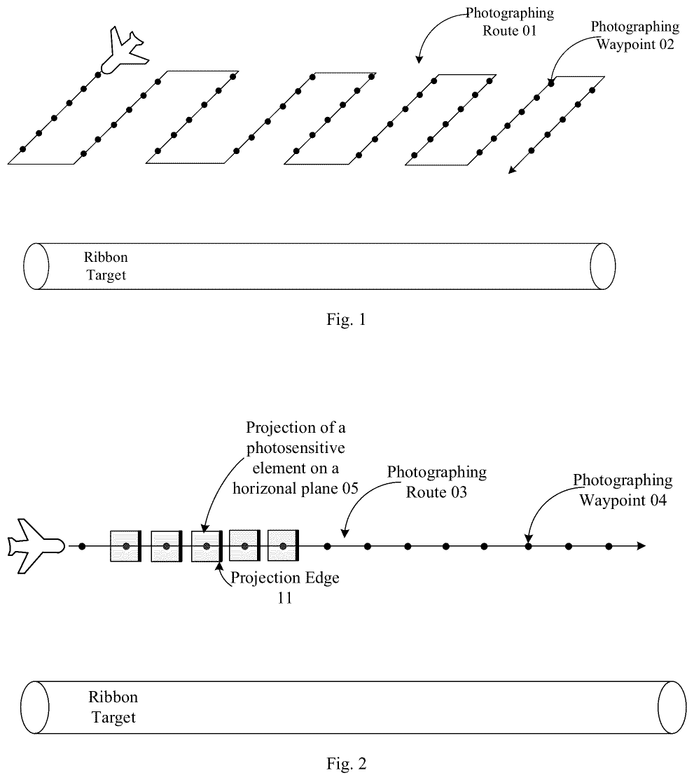

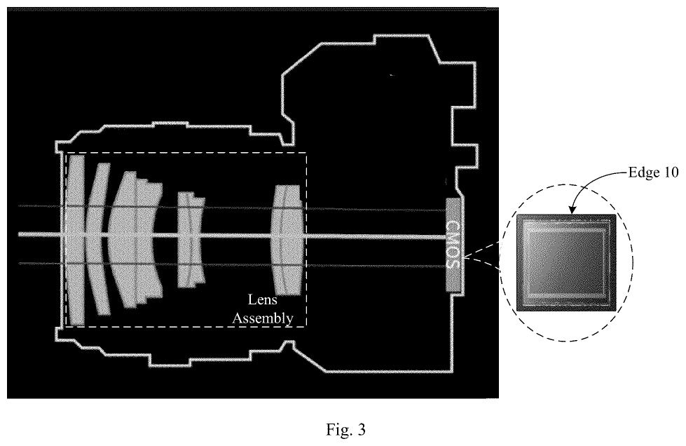

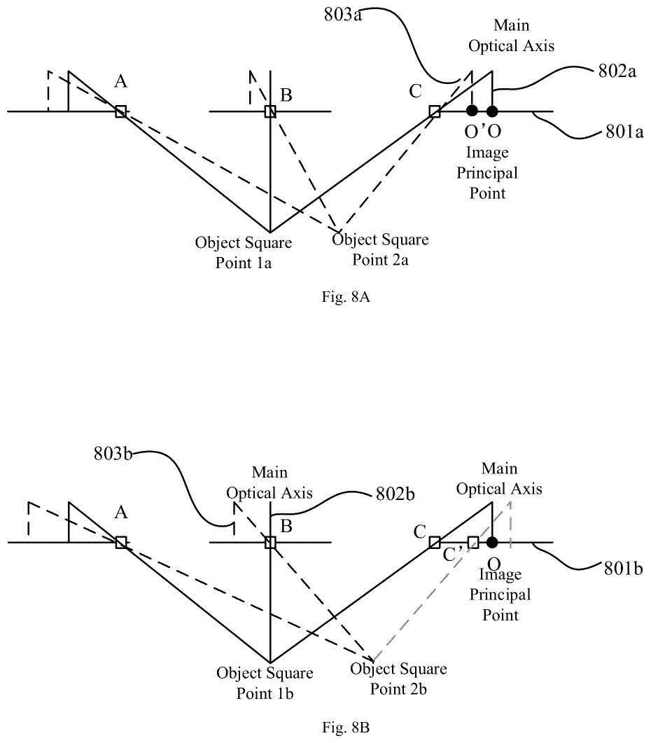

In view of the problems in the related technology, one embodiment to improve the photographing route for photographing the ribbon-shaped target into a photographing route 03 is shown in FIG. 2, which is a “single route” with only one route, and the heading direction of the photographing route 03 is the same as the extension direction of the ribbon-shaped target, so that the UAV can fly in accordance with the photographing route 03 and control the photographing device of the UAV to photograph images about the ribbon-shaped target at the photographing waypoints during the flight. The UAV can fly in accordance with the photographing route 03 and control the photographing device of the UAV to take images of the ribbon-shaped target at the photographing waypoints during the flight. As shown in FIG. 2, the projections 05 of the photosensitive elements of the photographing device on the horizontal plane at different photographing waypoints 04 are generally in the same direction (hereinafter the direction of the projections of the photosensitive elements on the horizontal plane is illustrated in connection with FIG. 3). Whereas, based on the aerial triangulation algorithm, the results of the one or more internal parameters solving of the photographing device using the image of the ribbon-shaped target captured along the photographing route 03 shown in FIG. 2 are inaccurate (illustrated in the embodiment shown in FIG. 8A), thereby resulting in inaccuracy of the results of the aerial surveys of the ribbon-shaped target obtained by the solving of the images of this type. As a result, such images can be used only for viewing purposes and not for mapping reference.

In order to facilitate understanding of the method of aerial survey by a UAV of a ribbon-shaped target provided by some embodiments of the present invention, the orientation of the projection of the photosensitive element on a horizontal plane is first described herein: the UAV is provided with a photographing device, the photographing device comprising a photosensitive element or structure, and the photosensitive element is, for example, a complementary metal oxide semiconductor (CMOS) sensor or a charge-coupled device (CCD) sensor. Referring to FIG. 3, after the shutter is pressed, light from the external environment irradiates the photosensitive element (e.g., the CMOS in FIG. 3) through the lens assembly in the photographing device, and the photosensitive element converts the received light signal into an electrical signal, which then generates an image through a subsequent series of processing. Therein, the mounting position of the photosensitive element in the photographing device is generally fixed. Taking one of the edges (edge 10) of the photosensitive element as an example, after projecting the photosensitive element on a horizontal plane, the edge 10 of the photosensitive element is projected as the projection edge 11 in FIG. 2, and it can be seen that the projection edges 11 corresponding to the edge 10 in FIG. 2 are all located on the same side, in which case it can be assumed that the projections of the photosensitive element of the photographing device on a horizontal plane at different recording waypoints are oriented in the same direction. The orientation of the projection of the photosensitive element of the photographing device in the horizontal plane at different photographing waypoints can be considered the same in this case.

Aiming at the problems in the “bow-shaped” route shown in FIG. 1 and the “single route” shown in FIG. 2 in the related art, some embodiments of the present invention provide a method of UAV aerial surveying of a ribbon target, which is capable of planning a photographing route for photographing a ribbon-shaped target according to position information of the ribbon target. Based on the position information of the ribbon target, a photographing route is planned for photographing the ribbon target, which is different from the “bow-shaped” route and the “single route” in the related technology. The photographing route planned by one embodiment of the present invention for photographing the ribbon-shaped target includes a first route and a second route, and the extension directions of the first route and the second route are both approximately the same as the extension direction of the ribbon-shaped target, and the length of the first route is shorter than the length of the second route, and the number of routes is less than that of the “bow-shaped” route. The length of the first route is shorter, which is conducive to shorten the voyage. The length of the first route is shorter than that of the second route, and the number of routes is less than the number of “bow-shaped” routes, and the length of the first route is shorter, thereby favoring shortening the voyage and improving the flight efficiency; the first route comprises a first photographing waypoint, and the UAV obtains a first image by photographing at the first photographing waypoint, and the second route comprises a second photographing waypoint, and the UAV obtains a second image by photographing at the second photographing waypoint. Orientation of the projection of the photosensitive element on the horizontal plane corresponding to the first image and orientation of the projection of the photosensitive element on the horizontal plane corresponding to the second image are different, thereby facilitating improvement of accuracy of the aerial survey results generated based on the first image and the second image.

Some embodiments of the present invention provide a method for UAV aerial surveying of a ribbon-shaped target that can be applied in an aerial surveying device. Exemplarily, the aerial survey device may be a cell phone, a computer, a tablet, a wearable device or a remote control among others. In one example, the method for aerial survey by a UAV of a ribbon-shaped target provided by some embodiments of the present invention may be a program product integrated in an aerial survey device. In another example, the aerial survey device comprises a memory, and the method for aerial survey of a UAV with a ribbon-shaped target provided by embodiments of the present invention may be executable instructions stored in the memory.

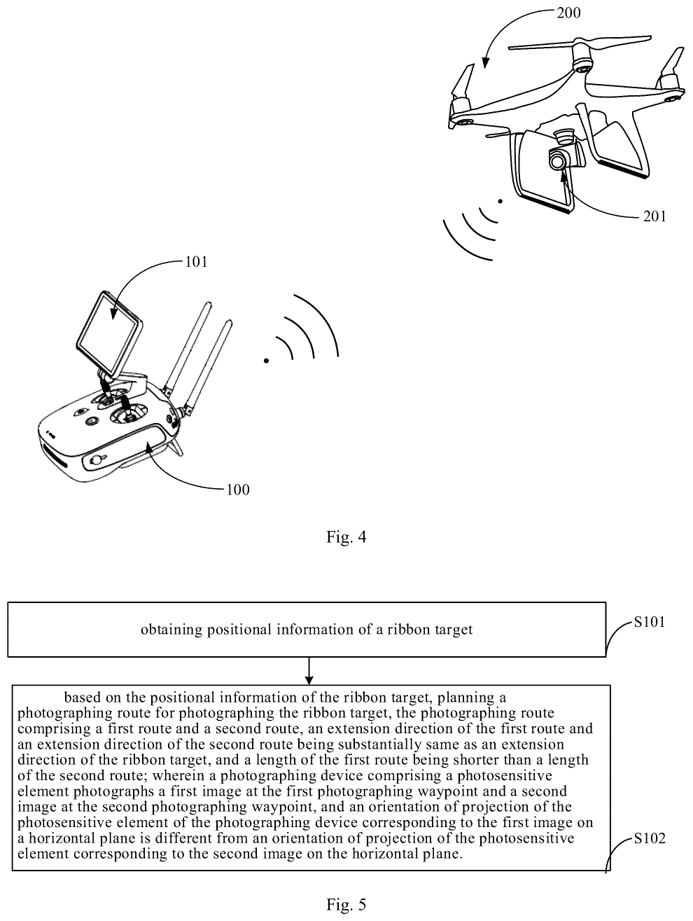

In an exemplary application scenario, refer to FIG. 4, which illustrates a schematic diagram of an unmanned aerial system, the unmanned aerial system comprising a remote control device 100 and a UAV 200; the remote control device 100 is provided with a display 101, and the UAV 200 is provided with a photographing device 201. wherein the remote control device 100 may execute the aerial survey method for the ribbon-shaped target with the UAV 200 provided in the embodiments of the present invention, comprising obtaining positional information of the ribbon target, and planning a photographing route for photographing the ribbon-shaped target based on the positional information of the ribbon target, whereby relevant information of the planned photographing route can be sent to the UAV 200, and the UAV 200, in the process of flying in accordance with the photographing route, can control the photographing device 201 to photograph images with respect to the ribbon target.

Exemplarily, the UAV 200 may send the captured images to the remote control device 100 so as to generate, by the remote control device 100, an aerial survey result of the ribbon-shaped target based on the captured images, and display the aerial survey result of the ribbon-shaped target in the display 101. Exemplarily, the UAV 200 may also generate aerial survey results of the ribbon-shaped target based on the captured images and then send the aerial survey results of the ribbon-shaped target to the remote control device 100, which may display the aerial survey results of the ribbon-shaped target in the display 101 of the remote control device 100. Exemplarily, the UAV 200 may send the captured images to a preset server, which generates the aerial survey results of the ribbon-shaped target based on the captured images and sends the aerial survey results of the ribbon-shaped target to the remote control device 100, which may display the aerial survey results of the ribbon-shaped target in the display 101 of the remote control device 100. The aerial survey results include, but are not limited to, an orthophoto, a digital elevation model, a digital surface model, a digital line drawing map, or a 3D model.

It will be apparent to those skilled in the art that other types of UAVs may be used without limitation, and embodiments of the present invention may be applied to various types of UAVs. For example, the UAV may be a small or large UAV. In some embodiments, the UAV may be a rotorcraft, e.g., a multi-rotor UAV propelled by air by a plurality of propulsion devices, and embodiments of the present invention are not limited thereto, and the UAV may also be other types of UAVs.

Referring to FIG. 5, FIG. 5 shows a flow diagram of a method of aerial survey of a UAV for a ribbon-shaped target provided by an embodiment of the present invention, the method being applied to an aerial survey device. Exemplarily, the aerial survey device may be a remote control device for controlling a UAV. The described method comprises:

In step S101, obtaining positional information of the ribbon target.

In step S102, according to the positional information of the ribbon target, planning a photographing route for photographing the ribbon target, the photographing route comprising a first route and a second route, the extension directions of the first route and the second route being approximately the same as the extension direction of the ribbon target, and the length of the first route being shorter than the length of the second route; wherein the first route comprises first photographing waypoints, the second route comprising second photographing waypoints, the first images captured by the UAV at the first photographing waypoint and the second images captured by the UAV at the second photographing waypoint being used to generate an aerial survey result of the ribbon target. A projection of a photosensitive element of the photographing device on a horizontal plane corresponding to the first image is oriented differently from a projection of the photosensitive element on the horizontal plane corresponding to the second image.

It is to be understood that the embodiments of the present invention do not impose any limitation on the process of obtaining the positional information of the ribbon-shaped target such as a river, a road, a railroad track, an oil pipeline or a natural gas pipeline, etc., and may be set up specifically according to actual application scenario.

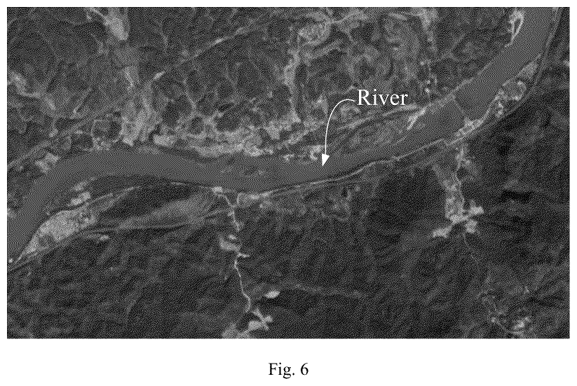

Exemplarily, the remote control device includes a display, and a map including a ribbon-shaped target may be displayed on the display according to actual need of the user, and thus the positional information of the ribbon-shaped target may be obtained according to a selection operation of the user in the map with respect to the ribbon target. As shown in FIG. 6, a river (the ribbon target) is displayed in the map of FIG. 6, and before planning a photographing route for photographing the river, the user may select a region where the river is located in the map of FIG. 6, and the remote control device may obtain positional information of the river based on the location selected by the user in the map, and then plan a photographing route for photographing the river based on the positional information of the river.

Exemplarily, the positional information of the ribbon-shaped target may also be the result of input by the user directly in the remote control device, for example, the user may obtain the latitude and longitude information of the ribbon-shaped target with the help of a positioning device, and then input the latitude and longitude information of the ribbon-shaped target into the remote control device.

In some embodiments, a photographing route may be planned for photographing the ribbon-shaped target based on the positional information of the ribbon-shaped target. Exemplarily, the remote control device may plan a photographing route for photographing the ribbon-shaped target based on the positional information of the ribbon-shaped target, and send the relevant information of the photographing route to the UAV so that the UAV flies in accordance with the photographing route and controls the photographing device to photograph images with respect to the ribbon-shaped target during the flight.

The photographing route planned by the embodiment of the present invention may comprise a first route and a second route, wherein the extension directions of the first route and the second route are substantially the same as the extension direction of the ribbon target. Wherein, “substantially the same” includes two cases, one is that the extension directions of the first route and the second route completely coincide with the extension direction of the ribbon target, and the other is that the extension directions of the first route and the second route have a predetermined angular deviation from the extension direction of the ribbon target, and the predetermined angle has a small angular value, such as less than 5°, 10°, or 15°, and the specific value can be specifically set according to actual application scenario.

In one embodiment, the first route comprises first photographing waypoints and the second route comprises second photographing waypoints, wherein the first images taken by the UAV at the first photographing waypoints and the second images taken by the UAV at the second photographing waypoints are used to generate an aerial survey result of the ribbon target, and wherein the orientation of the projection of the photosensitive element corresponding to the first images on the horizontal plane and the orientation of the projection of the photosensitive element corresponding to the second image are different, thereby contributing to improving the accuracy of the aerial survey result.

Moreover, the purpose of planning out the first route in the present invention is to obtain a first image in which the orientation of the projection of the photosensitive element on the horizontal plane is different from the orientation of the projection of the photosensitive element on the horizontal plane corresponding to the second image so as to assist in accuracy of the one or more internal parameters determination of the photographing device, thereby improving the accuracy of the results of the aerial surveys, i.e., the first route serves as a supplementary function. Therefore, the embodiment of the present invention sets the length of the first route to be shorter than the length of the second route, thereby contributing to improvement of the flight efficiency.

In one embodiment, in order to further improve the accuracy of the one or more internal parameters determination of the photographing device, the length of the first route cannot be set too short, and if the length is set too short, it may not be possible to capture a sufficient number of first images, and the accuracy of the one or more internal parameters determination of the photographing device cannot be guaranteed, which in turn affects the accuracy of the aerial survey results. Therefore, the length of the first route may be adaptively set based on the length of the second route, for example, the ratio between the length of the first route and the length of the second route may be set to be greater than a predetermined ratio, and the predetermined ratio may be specifically set based on an actual application scenario, for example, the predetermined ratio may be 1:2, or the predetermined ratio may be 2:5, and so on.

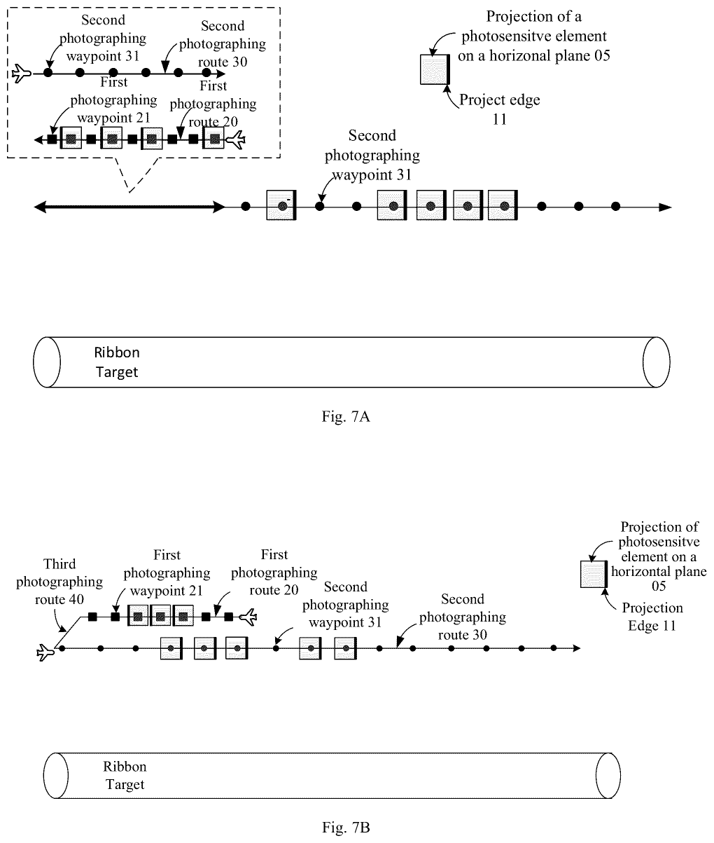

In an exemplary embodiment, the photographing route obtained by the planning of the embodiment of the present invention may be a photographing route as shown in FIGS. 7A and 7B, the photographing route comprising a first route 20 and a second route 30, the first route 20 comprising a first photographing waypoint 21 and the second route 30 comprising a second photographing waypoint 31.

Exemplarily, in the case where the end point of the first route 20 is the same as the start point of the second route 30, it may be a photographing route as shown in FIG. 7A, where the heading direction of the first route 20 is opposite to that of the second route 30, and where the heading direction of the second route 30 is in substantially the same direction of the extension of the ribbon target; in the process of the UAV flying in accordance with the photographing route, the UAV, after taking off from the start point of the first route 20, adjusts the heading in situ at the end point of the first route 20, for example, the UAV may realize the adjustment of the heading by turning the nose direction in situ at the end point of the first route 20, and thus fly in accordance with the second route 30.

In one embodiment, in order to achieve accurate photographing of the ribbon target, in the case where the end point of the first route 20 is the same as the start point of the second route 30, the first route 20 and the second route 30 may be located substantially above the centerline of the ribbon target. Wherein, “being located substantially above the centerline of the ribbon target” may include several situations: one is that the projections of the first route 20, the second route 30 and the centerline of the ribbon-shaped target on the horizontal reference plane at least partially coincide; another is that the projections of the first route 20, the second route 30 and the centerline of the ribbon-shaped target on the horizontal reference plane are less than a predetermined distance apart from each other, and the interval between the projections of the first route 20 and the second route 30 and the centerline of the ribbon-shaped target on the horizontal reference plane is less than a preset distance, the predetermined distance being small; and another is that the angle between the projections of the first route 20, the second route 30 and the ribbon-shaped target centerline on the horizontal reference plane is less than a predetermined angle, the predetermined angle being small. The specific values of the above predetermined values may be specifically set based on the actual application scenario.

Exemplarily, in the case where the end point of the first route 20 is different from the start point of the second route 30, it may be a photographing route as shown in FIG. 7B, wherein the heading direction of the first route 20 is opposite to the heading direction of the second route 30, and wherein the heading direction of the second route 30 is in substantially the same direction as the extension of the ribbon target. The photographing route further comprises a third route 40 comprising the end point of the first route 20 and the start point of the second route 30; the third route 40 may be a straight flight route or a curved flight route. When the UAV flies to the end point of the first route 20 in accordance with the first route 20, the UAV adjusts its heading direction from the heading direction of the first route 20 to the heading direction of the second route 30 by means of the third route 40, e.g., the UAV may achieve the purpose of adjusting the heading direction by turning the nose direction in the course of flying in accordance with the third route 40.

In one embodiment, in the case where the end point of the first route 20 is different from the start point of the second route 30, considering that the first route 20 mainly plays an auxiliary role in improving the accuracy of the aerial survey results, while the second route 30 is mainly used for taking second images about the ribbon target, in order to realize accurate photographing of the ribbon target, the second route 30 may be located approximately directly above the centerline of the ribbon target, and the first route 20 is located on one of the sides of the second route 30.

In some embodiments, referring to FIG. 7A as well as FIG. 7B, FIGS. 7A and 7B exemplarily illustrate the orientation of the projection of the photosensitive element of the photographing device on the horizontal plane in the first route, and the orientation of the projection of the photosensitive element of the photographing device on the horizontal plane in the second route. The mounting position of the photosensitive element in the photographing device is fixed, and referring to FIG. 3, taking the projection edge 11 of one of the edges (the edge 10) of the photosensitive element on the horizontal plane as an example, the projection edges 11 of the edge 10 of the photosensitive element on the horizontal plane in FIGS. 7A and 7B are on different sides in different flight routes, i.e., the orientation of the projection of the photosensitive element of the photographing device in the first route is different from that of the projection of the photosensitive element of the photographing device in the second route. Wherein the edge 10 of the photosensitive element corresponding to different photographing waypoints in the same route is on the same side of the projection edge 11 on the horizontal plane, i.e., the projections of the photosensitive element corresponding to different first photographing waypoints in the first route have the same orientation on the horizontal plane, and the projections of the photosensitive element corresponding to different second photographing waypoints in the second route have the same orientation on the horizontal plane. It should be noted that the projected edge 11 is used to represent the orientation of the photosensitive element, and is not necessarily present as a projected edge.

In some embodiments, the first images taken by the photographing device at the first photographing waypoints of the first route and the second images taken at the second photographing waypoints of the second route are used to generate an aerial survey result of the ribbon target, the basic principle of which is to calculate the photographing position of each image, and then utilize an image fusion algorithm to fuse the multiple images into a single aerial survey image that can be used to measure the geographic information, which can be, for example, at least one of an orthophoto, a digital elevation model, a digital surface model, a digital line drawing map, or a 3D model.

In calculating the photographing position of the respective image, it is necessary to obtain one or more internal parameters of the photographing device and geographic coordinates of the photographing device when photographing the respective image. Wherein, the one or more internal parameters include a focal length of the photographing device and/or an image principal point image position of the photographing device. The image principal point image position refers to the intersection of the main optical axis of the lens of the photographing device and the image plane (i.e., the photosensitive element), and when the photosensitive element is fixed and unchanged, the image principal point image position can be determined after the main optical axis of the lens of the photographing device is determined. The focal length is the distance between the optical center and the photosensitive element. When the photosensitive element is fixed, the focal length of the photographing device can be obtained by determining the optical center. The geographic coordinates can be determined from the data collected by the relevant positioning module in the UAV.

In order to improve the accuracy of the aerial survey results, it is realized in some embodiments of the present invention that the orientation of the projection of the photosensitive element of the photographing device on the horizontal plane in the first route is different from the orientation of the projection of the photosensitive element of the photographing device on the horizontal plane in the second route, so that the first images captured by the UAV at the first photographing waypoints and the second images captured by the UAV at the second photographing waypoints can be obtained from the accurate one or more internal parameters of the photographing device. Then, a higher accuracy of the aerial survey result can be generated based on the one or more internal parameters and the second images, thereby improving the accuracy of the aerial survey result. Of course, it is also possible to generate the aerial survey results based on the one or more internal parameters of the photographing device, the first image, and the second image, and the present embodiment does not impose any limitation thereon. Wherein, after the UAV obtains the first image and the second image by photographing using the photographing device, the process of generating the aerial survey results utilizing the first image and the second image may be carried out when the remote control device is in an offline environment, or it may be carried out in real time by the remote control device.

In determining the internal parameter of the photographing device, the one or more internal parameters of the photographing device may be calculated based on the target image square points in the first image and the second image. The target image square points are image points of a target object in the photographing environment of the photographing device on the first image and the second image, respectively. Wherein the target image square point on the first image and the target image square point on the second image can be understood as a pair of correlated image square points, the correlated image square points are for a certain target object, which is captured in both the first image and the second image captured by the photographing device, the image square point corresponding to the target object in the first image and the image square point corresponding to the target object in the second image are a pair of correlated image square points.

In an exemplary embodiment, the one or more internal parameters of the photographing device include the image principal point image position, for example: referring to FIG. 8A, when the UAV is flying in accordance with a “single route” as shown in FIG. 2, the projections of the photosensitive element on the horizontal plane at different photographing waypoints are oriented in the same direction, and the image principal point image position of the photographing device is calculated in such a situation. In FIG. 8A, 801a refers to the photosensitive element of the photographing device, and A, B, and C are the target image square points on the three images obtained by the photographing device of the unmanned aerial vehicle at three different photographing waypoints in the “single flight route” shown in FIG. 2. Assuming that the main optical axis of the photographing device is 802a, there is an optical route through the main optical axis and the target image square point in all three images converging at the object square point 1a, that is to say, when the main optical axis is 802a, there exists an object square point that makes an projection just overlap with the three target image square points, which is consistent with the projection model of the photographing device. The image principal point is the intersection of the main optical axis of the photographing device and the photosensitive element, and therefore, under the assumption that 802a is the main optical axis, an image principal point O is determined.

If it is assumed that the main optical axis is 803a, it is easy to see from FIG. 8A that there still exists an object square point 2a at which the optical routes through the main optical axis 803a and the three target image square points intersect, and such a situation also conforms to the projection model of the photographing device, and therefore the image main point of the photographing device can be determined to be O′ according to the main optical axis 803a. It can be seen that in FIG. 8A, when the UAV is flying in accordance with a “single route” as shown in FIG. 2, if the projections of the photosensitive element on the horizontal plane in the different photographing waypoints have the same orientation, at least two image principal point image positions of the photographing devices can be calculated based on the target images square points of the images taken in the photographing waypoints. Which image principal point image position among the two image principal point image positions is selected as the correct image principal point image position of the photographing device cannot be determined. If the wrong image principal point image position is selected as the internal parameter of the photographing device, the generated aerial survey results deviate in the horizontal direction.

Obviously, if the projections of the photosensitive element on the horizontal plane in different photographing waypoints are oriented in the same direction, multiple main optical axes can be calculated when calculating the one or more internal parameters of the photographing device using the aerial triangulation algorithm to obtain the image principal point image position of the photographing device, in which it is not possible to accurately determine which main optical axis is the target main optical axis, and it is not possible to accurately determine the image principal point image position of the photographing device. Accordingly, the one or more internal parameters of the photographing device is inaccurate, thereby resulting in errors in the final generated aerial survey results.

Referring to FIG. 8B, when the UAV is flying in accordance with a photographing route provided in an embodiment of the present invention, an orientation of a projection of a photosensitive element of the photographing device on a horizontal plane in the first route is different from an orientation of a projection of the photosensitive element of the photographing device on the horizontal plane in the second route, and an image principal point image position of the photographing device is computed in such a case. In FIG. 8B, 801b refers to a photosensitive element in the photographing device, A and B are target image square points on the two second images, and C is a target image square point on the first image, and the orientation of the projection of the photosensitive element on the horizontal plane corresponding to the first image is different from the orientation of the projection of the photosensitive element on the horizontal plane corresponding to the two second images. In FIG. 8B, if it is assumed that the main optical axis is 802b, three light routes passing through the main optical axis and the three target image square points may converge at the object square point 1b, in accordance with the projection model of the photographing device, and at this time, the image principal point image position determined according to the main optical axis 802b and the photosensitive element is O. If it is assumed that the main optical axis is 803b, it can be seen from FIG. 8B that the optical route passing through the target image square points on the two second images and the main optical axis 803b intersects at the object square point 2b. In this case, if the object square point 2b is projected onto the first image, the target image square point corresponding to the object square point 2b on the first image obtained is not C, but becomes C′, which does not conform to the projection model of the photographing device, and which indicates that the main optical axis at this point in time is wrong. As can be seen, a main optical axis 802b can be uniquely determined by means of FIG. 8B, and the image principal point image position O determined according to the main optical axis 802b is the correct internal parameter of the photographing device.

Obviously, if the orientation of the projection of the photosensitive element on the horizontal plane corresponding to the first image and the orientation of the projection of the photosensitive element on the horizontal plane corresponding to the second image are different, a main optical axis can be uniquely determined when calculating the one or more internal parameters of the photographing device by using the airborne triangulation algorithm, and thus an accurate image principal point image position can be determined, realizing an accurate determination of the one or more internal parameters of the photographing device, which is conducive to enhancing the accuracy of the results of the aerial survey.

In some embodiments, the UAV is provided with a gimbal, and during the flight of the UAV in accordance with the photographing route, the gimbal may be rotated by controlling the gimbal to make the orientation of the projection of the photosensitive element of the photographing device on the horizontal plane in the first route different from the orientation of the projection of the photosensitive element of the photographing device on the horizontal plane in the second route.

In some embodiments, during the flight of the UAV following the photographing route, the nose direction may be changed so that the orientation of the projection of the photosensitive element of the photographing device on the horizontal plane in the first route is different from the orientation of the projection of the photosensitive element of the photographing device on the horizontal plane in the second route.

In order to further improve the accuracy of the aerial measurement results, the orientation of the projection of the photosensitive element corresponding to the first image on the horizontal plane may be set to be opposite to the orientation of the projection of the photosensitive element corresponding to the second image on the horizontal plane. In this way, when performing the determination of the one or more internal parameters of the photographing device, for example, in FIG. 8B, the wrong object square point 2b is not projected onto the image square point, which does not satisfy the projection model, the correct main optical axis can be screened based on the aerial triangulation algorithm, and thus an accurate internal parameter of the photographing device such as the image principal point image position can be obtained.

Exemplarily, the UAV may be set to have a nose direction when flying along the first route opposite to the nose direction when flying along the second route, so that the orientation of the projection of the photosensitive element corresponding to the first image on the horizontal plane is opposite to the orientation of the projection of the photosensitive element corresponding to the second image on the horizontal plane. In one example, referring to FIGS. 7A and 7B, the UAV, when flying to the end of the first route, can change its heading direction by turning the nose direction to continue the flight of the second route, and in the process also realizes that the orientation of the projection of the photosensitive element of the photographing device on the horizontal plane in the first route is different from the orientation of the projection of the photosensitive element of the photographing device on the horizontal plane in the second route.

In some embodiments, the length of the first route is shorter than the length of the second route. In order to increase accuracy of one or more internal parameters of the photographing device (like the image principal point image position), the density of the first photographing waypoints in the first route may be set higher than the density of the second photographing waypoints in the second route. Exemplarily, referring to FIGS. 7A and 7B, for example, in terms of the distance between neighboring photographing waypoints, there is a distance between two neighboring first photographing waypoints in the first route that is smaller than the distance between two neighboring second photographing waypoints in the second route, i.e. the distance between two neighboring first photographing waypoints will be smaller, and thus the first photographing waypoints in the first route will be more dense. Exemplarily, from an imaging perspective, there are first images captured by the photographing device at the two adjacent first photographing waypoints that satisfy a first overlapping rate, and second images captured by the photographing device at the two adjacent second photographing waypoints that satisfy a second overlapping rate, wherein the first overlapping rate is greater than the second overlapping rate, e.g., wherein the first overlapping rate is 70% and the second overlapping rate is 50%. In this embodiment, in the case where the length of the first route is shorter than the length of the second route, it is realized that the first photographing waypoints in the first flight route are more densely packed, so as to be able to collect a sufficient number of the first images to participate in the determination of one or more internal parameters (e.g., image principal point position) of the photographing device, which is conducive to determining the correct image principal point image position.

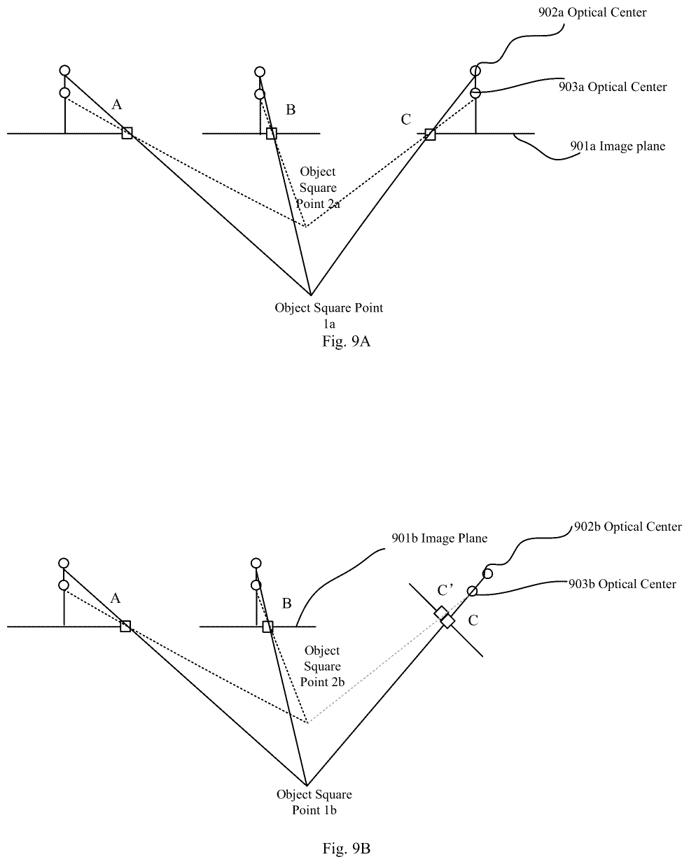

In some embodiments, the one or more internal parameters of the photographing device comprise a focal length and/or an image principal point image position of the photographing device. By acquiring a first image and a second image, the orientation of the projection of the photosensitive element on the horizontal plane corresponding to the first image and the orientation of the projection of the photosensitive element on the horizontal plane corresponding to the second image are different, and determination of the correct image principal point image position can be realized. In addition, it is considered that if the photographing device at different photographing waypoints all face the same direction as the direction of gravity, in this case, when calculating the one or more internal parameters of the photographing device using the airborne triangulation algorithm, the focal length of the photographing devices cannot be accurately determined, which leads to elevation errors in the generated aerial survey results (for the relevant content, please refer to the illustration in the embodiment shown in FIG. 9A). Therefore, in order to realize solving the correct focal length, the accuracy of the calculated focal length of the photographing device can be ensured by setting the orientation of the photographing device at different photographing waypoints to differ.

In an exemplary embodiment, the calculation relationship between the orientation of the photographing device and the focal length of the photographing device is exemplified herein, referring to FIGS. 9A and 9B, wherein in the embodiment shown in FIG. 9A, the orientation of the photographing device when the UAV is flying along the first route as well as the orientation of the photographing device when it is flying along the second route are in the same direction as the direction of gravity, and wherein the focal length of the photographing device is calculated. In FIG. 9A, 901a is an image plane, A and B are target image square points on the two second images, and C is a target image square point on the first image, where both the first image and the two second images correspond to the photographing device oriented in the same direction as the direction of gravity. If 902a is assumed to be the optical center, the optical route through the optical center 902a and the three target image square points intersect at the object square point 1a, which conforms to the projection model of the photographing device, indicating that the optical center 902a may be the optical center of the photographing device, and the distance f from the optical center 902a to the photosensitive element 901a denotes the focal length of the photographing device.

If it is assumed that 903a is the optical center, it can be seen in FIG. 9A that the optical route through the optical center 903a and the three target image square points can still intersect at the object square point 2a, which also conforms to the projection model of the photographing device, indicating that the optical center 903a can also be the optical center of the photographing device, and that the distance f between the optical center 903a and the photosensitive element 901a denotes the focal length of the photographing device. As can be seen, if the photographing device is oriented in the same direction as the direction of gravity when the photographing device photographs the first image and the second image, at least two focal lengths of the photographing device can be obtained, and it is not possible to accurately select which one of the at least two focal lengths is the correct focal length of the photographing device, and once a wrong focal length of the photographing device is selected, it will lead to errors in the aerial survey results in terms of elevation.

In one embodiment shown with reference to FIG. 9B, the photographing device for photographing at a waypoint is oriented in a direction different from the direction of gravity, in which case a focal length of the photographing device is calculated. An orientation of the photographing device refers to a direction the photographing device faces. In FIG. 9B, 901b is an image plane, and assuming that A and B are target image square points on the two second images and C is a target image square point on the first image, the photographing device corresponding to at least one of the first image and the two second images is oriented in a direction different from the direction of gravity. For example, the photographing device corresponding to the first image is oriented to tilt 10° to the left with respect to the direction of gravity, and the photographing device corresponding to the second image is oriented to tilt 10° to the right with respect to the direction of gravity. If 902b is assumed to be the optical center, the three light routes through the center of light 902b and the three target square points can converge at the object square point 1b, which conforms to the projection model of the photographing device, indicating that 902b is the optical center of the photographing device, and further the distance between the optical center 902b and the photosensitive element 901b is taken as the focal length f of the photographing device.

In FIG. 9B, if 903b is assumed to be the optical center, two optical routes through the optical center 903b and two target image square points on the two second images can be converged to the object square point 2b, but the image square point obtained by projecting the object square point 2b onto the target image is C′, which is not the same as the target image square point on the first image, and this phenomenon does not conform to a projection model of the photographing device, and therefore it can be determined that the optical center 903b is not the optical center of the photographing device. Similarly, for the object square points determined by the optical centers other than the optical center 902b do not satisfy the projection model of the photographing device, and they are not listed herein. In summary, there is only one optical center 902b in FIG. 9B that satisfies the projection model, and therefore the distance f between the optical center 902b and the photosensitive element is taken as the focal length of the photographing device.

In summary, the photographing device, by setting the photographing waypoints with the photographing device facing a different direction from the direction of gravity, can avoid getting a plurality of focal lengths of the photographing device by calculation, and can more accurately determine a unique focal length of the photographing device, thereby improving the elevation accuracy of the subsequently generated aerial survey results.

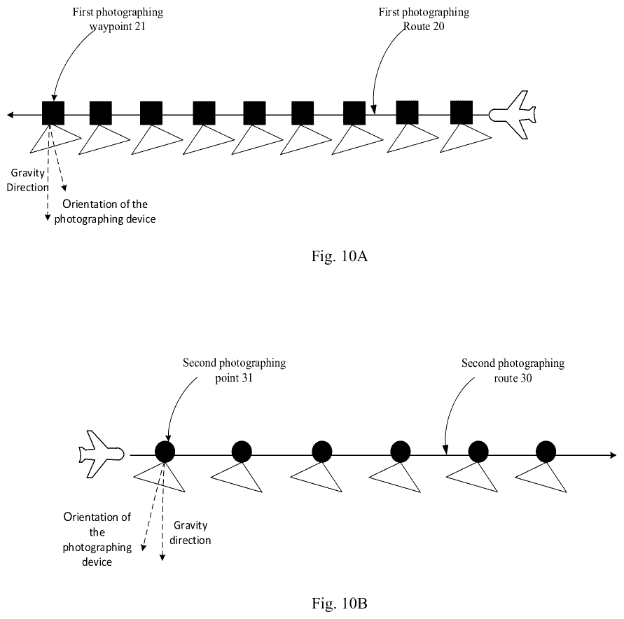

In one embodiment, it is possible to set the orientation of the photographing device of the UAV when flying along the first route to be different from the orientation of the photographing device when flying along the second route. Exemplarily, it is possible, for example, to set the angle between the orientation of the photographing device of the UAV and the direction of gravity when flying along the first route and the angle between the orientation of photographing device orientation and the direction of gravity when flying along the second route to be opposite numbers to each other. In one example, referring to FIG. 10A and FIG. 10B, FIG. 10A illustrates that the photographing device at the first photographing waypoint in the first flight route is tilted to the right with respect to the direction of gravity, and FIG. 10B illustrates that the photographing device at the second photographing waypoint in the second flight route is tilted to the left with respect to the direction of gravity, which realizes that the photographing device at the different photographing waypoints is differently tilted with respect to the direction of gravity. Accordingly, the focal length of the photographing device is accurately determined, so as to improve the elevation accuracy of the subsequently generated aerial survey results. In some embodiments, both of the angle between the orientation of the photographing device of the UAV and the direction of gravity when flying along the first route and the angle between the orientation of photographing device orientation and the direction of gravity when flying along the second route are tilted in the same direction, and are set different values.

Exemplarily, in the first route, the angles at which the photographing device corresponding to different first photographing waypoints respectively is tilted relative to gravity may be the same or different; similarly, in the second route, the angles at which the photographing device corresponding to different second photographing waypoints respectively is tilted relative to gravity may be the same or different.

In one example, referring to FIG. 10A, it is assumed that in the first route, the photographing device corresponding to different first photographing waypoints is respectively tilted to the right with respect to the direction of gravity, and the angle of tilt (i.e., the angle between orientation of the photographing device and the direction of gravity) may be different, e.g., it may be gradually increased from 0° to a preset angle, or gradually decreased from a preset angle to 0°. The specific value of the predetermined angle and the rule of variation of the increase or decrease can be set according to the actual application scenario, and the present embodiment does not impose any limitation thereon, such as the difference between the angles between the orientation of the photographing device and the direction of gravity corresponding to the neighboring photographing waypoints is the same, or satisfies the equal-proportionate series, the equal-difference series, and so on.

Similarly, referring to FIG. 10B, it is assumed that in the second route, the photographing device corresponding to the different second photographing waypoints are respectively tilted to the left with respect to the direction of gravity, and the angle of the tilt (i.e., the angle between the orientation of the photographing device and the direction of gravity) may be different, for example, it may be gradually increased from 0° to a predetermined angle, or it may be gradually decreased from a predetermined angle to 0°.

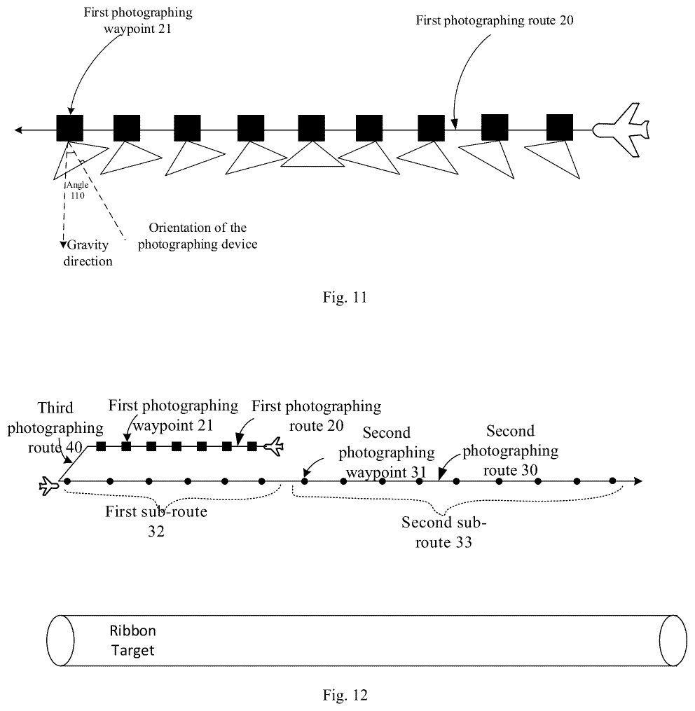

In one embodiment, the UAV may be set up with a gradual change in the orientation of the photographing device while flying along the first route. Exemplarily, in order to improve the accuracy of the determination of the focal length of the photographing device, referring to FIG. 11, the angle 110 value between the orientation of the photographing device and the direction of gravity when the UAV is flying along the first route may become smaller and then larger, i.e., orientation of the photographing device in the first route exhibits a tendency to converge, for example, the angle changes from large to small to zero and then from zero to large again, so that when performing the determination of the one or more internal parameters of the photographing device, for example, in FIG. 9B, the three projected lines do not intersect at one object square point, which does not satisfy the projection model, and the correct optical center can be screened out based on the airborne triangulation algorithm, thus obtaining the accurate one or more internal parameters (focal length) of the photographing device.

In one example, the angle 110 of the orientation of the photographing device relative to the direction of gravity at the first first photographing waypoint in the first route is a preset angle greater than 0°, and the angle 110 corresponding to the next first photographing waypoint can be reduced by a certain angular value (which can be set according to the actual application scenario) on the basis of the angle 110 corresponding to the previous first photographing waypoint, until the angle 110 corresponding to the first photographing waypoint is 0 (i.e. the photographing device corresponding to the first photographing waypoint is facing the same direction as the direction of gravity), and the angle 110 corresponding to the next first photographing waypoint can be increased by a certain angle value on the basis of the angle 110 corresponding to the previous first photographing waypoint, so as to realize the effect that the angle 110 corresponding to the first photographing waypoints of the first flight route can be made smaller and then larger.

In some embodiments, in determining the one or more internal parameters of the photographing device, the remote control device may calculate the one or more internal parameters of the photographing device based on the target image square points in the first image and the second image. Wherein the target image square point is an image point of a target object in the photographing environment of the photographing device on the first image and the second image respectively, i.e., the first image and the second image need to include the same target object. Then, the photographing device can be set to have a predetermined side-by-side overlapping rate between the second images taken at a part of the second photographing waypoints of the second route and the first images taken at the first photographing waypoints of the first route, so as to ensure that a part of the second images and the first images have the target image point, thereby facilitating the calculation of the one or more internal parameters of the photographing device. Of course, the specific value of the side-by-side overlapping rate may be specifically set according to the actual application scenario, and the embodiments of the present invention do not impose any limitation thereon.

Exemplarily, the second route comprises a first sub-route and a second sub-route, wherein the second image captured by the photographing device at a second photographing waypoint of the first sub-route and a first image captured at a first photographing waypoint of the first route have a predetermined side-by-side overlapping rate, and wherein the second image captured by the photographing device at a second photographing waypoint of the second sub-route and a first image captured at a first photographing waypoint of the first route do not overlap. FIG. 12, for example, illustrating the second route 30 comprising a first sub-route 32 and a second sub-route 33.

In some embodiments, after acquiring the first images captured by the photographing device in the first route and the second images captured in the second route, the remote control device may determine one or more internal parameters of the photographing device based on the first images and the second images, and then generate an aerial survey result of the ribbon-shaped target based on the one or more internal parameters of the photographing device and the second images, such as determining a photographing position of the photographing device when the photographing device captured the second images based on the one or more internal parameters of the photographing device and the geographic coordinates of the photographing device when the photographing device captured the second images. For example, photographing positions of the photographing device when photographing the second images can be determined based on the one or more internal parameters of the photographing device and the geographic coordinates of the photographing device when photographing the second images, and then the aerial survey results of the ribbon-shaped target can be generated based on the photographing positions of the photographing device when photographing the second images and in combination with the image fusion algorithm, and the aerial survey results include, but are not limited to, an orthophoto, digital elevation model, digital surface model, digital line drawing map, or a 3D model and the like. Of course, the aerial survey results of the ribbon-shaped target can also be generated based on the one or more internal parameters of the photographing device, the first images and the second images.

Therein, the timing of generating the aerial survey results may be selected according to actual needs, and in one example, the remote control device, after acquiring the first images and the second images, may determine the one or more internal parameters of the photographing device in real time based on the first images and the second images, and then generate the aerial survey results of the ribbon-shaped target based on the one or more internal parameters of the photographing device and the second images. In another example, the remote control device, after acquiring the first images and the second images, may also utilize the first images and the second images in an offline environment to generate the aerial survey results of the ribbon target.

The various technical features in the above embodiments can be combined arbitrarily, as long as there is no conflict or contradiction between the combinations of features, and therefore the arbitrary combination of the various technical features in the above embodiments also falls within the scope of the disclosure of this specification.

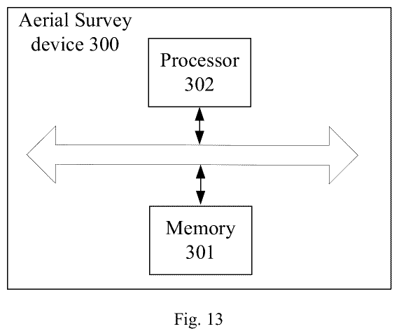

Referring to FIG. 13, some embodiments of the present invention also provide an aerial survey device 300, the UAV being provided with a photographing device, the photographing device comprising a photosensitive element, the aerial survey device comprising:
memory 301 for storing executable instructions;
one or more processors 302;
wherein the one or more processors 302, when executing the executable instructions, are individually or collectively configured to perform the method.

Exemplarily, the aerial survey device 300 may be a remote control device 100 as shown in FIG. 4.

The processor 302 executes executable instructions included in the memory 301, the processor 302 may be a Central Processing Unit (CPU), or other general purpose processor, Digital Signal Processor (DSP), Application Specific Integrated Circuit (ASIC), Field-Programmable Gate Array (FPGA) or other programmable logic device, discrete gate or transistor logic device, discrete hardware components, and the like. The general-purpose processor may be a microprocessor or the processor may be any conventional processor, etc.

The memory 301 stores executable instructions for the UAV aerial survey method, the memory 301 may comprise at least one type of storage medium, the storage medium comprising a flash memory, a hard disk, a multimedia card, a card-type memory (e.g., SD or DX memory, etc.), a random-access memory (RAM), a static random-access memory (SRAM), a read-only memory (ROM), an electrically erasable programmable read-only memory (EEPROM), programmable read-only memory (PROM), magnetic memory, disks, optical disks, and the like. Further, the device may collaborate with a networked storage device that performs storage functions of the memory via a network connection. The memory 301 may be an internal storage unit of the device 300, such as a hard disk or memory of the device 300. The memory 301 may also be an external storage unit of the device 300, such as a plug-in hard disk equipped on the device 300, a Smart Media Card (SMC), a Secure Digital (SD) card, a Flash Card, and the like. Further, the memory 301 may also include both an internal storage unit of the device 300 and an external storage device. The memory 301 may be used to store computer programs for the UAV aerial survey method and other programs and data required by the device. The memory 301 may also be used to temporarily store data that has been or will be output.

In some embodiments, the processor 302 is used for:
obtaining positional information for the ribbon target;
based on the positional information of the ribbon target, planning a photographing route for photographing the ribbon target, the photographing route comprising a first route and a second route, the first route and the second route extending in substantially the same direction as the extension direction of the ribbon target, and the length of the first route being shorter than the length of the second route;
wherein the first route comprises a first photographing waypoint and the second route comprises a second photographing waypoint, wherein the first image taken by the UAV at the first photographing waypoint and the second image taken by the UAV at the second photographing waypoint are used to generate an aerial survey result of the ribbon target, wherein the orientation of the projection of the photosensitive element on the horizontal image corresponding to the first image has a different orientation of the projection of the photosensitive element on the horizontal plane corresponding to the second image.

Optionally, the orientation of the projection of the photosensitive element on the horizontal plane corresponding to the first image is opposite to the orientation of the projection of the photosensitive element on the horizontal plane corresponding to the second image.

Optionally, the nose direction of the UAV when flying along the first route is opposite to the nose direction when flying along the second route so that the orientation of the projection of the photosensitive element corresponding to the first image on the horizontal plane is opposite to the orientation of the projection of the photosensitive element corresponding to the second image on the horizontal plane.

Optionally, the distance between two adjacent first photographing waypoints in the first route is less than the distance between two adjacent second photographing waypoints in the second route.

Optionally, in the first route, the first images captured by the photographing device at each of two adjacent first photographing waypoints satisfy a first overlapping rate; and in the second route, the second images captured by the photographing device at each of two adjacent second photographing waypoints satisfy a second overlapping rate; wherein the first overlapping rate is greater than the second overlapping rate.

Optionally, the orientation of the photographing device of the UAV when flying along the first route is different from the orientation of the photographing device when flying along the second route.

Optionally, the angle between the orientation of the photographing device of the UAV along the first route and the direction of gravity and the angle between the orientation of the photographing device along the second route and the direction of gravity are opposite numbers to each other.

Optionally, the orientation of the photographing device while the UAV is flying along the first route changes gradually.

Optionally, the angle between the orientation of the photographing device and the direction of gravity when the UAV is flying along the first route becomes smaller and then larger.

Optionally, a ratio between a length of the first route and a length of the second route is greater than a predetermined ratio.

Optionally, the end point of the first route is the same as the start point of the second route, and the UAV turns its nose direction in situ at the end point of the first route; or the end point of the first route is different from the start point of the second route, and the photographing route comprises a third route comprising the end point of the first route and the start point of the second route; and the UAV turns its nose direction in the course of flying in accordance with the third route.

Optionally, the third route is straight or curved.

Optionally, the first route ends at a different point than the second route starts, the second route is located substantially directly above the centerline of the ribbon target, and the first route is located on one side of the second route.

Optionally, the second route comprises a first sub-route and a second sub-route, and the second image captured by the capturing device at a second photographing waypoint of the first sub-route and a first image captured at a first photographing waypoint of the first route have a predetermined side-by-side overlapping rate.

Optionally, the aerial survey results include at least one of an orthophoto, a digital elevation model, a digital surface model, a digital line drawing, or a 3D model.

Various implementations described herein may be implemented using, for example, computer software, hardware, or any combination thereof on a computer-readable medium. For hardware implementations, the implementations described herein may be implemented by using at least one of an application-specific integrated circuit (ASIC), a digital signal processor (DSP), a digital signal processing device (DSPD), a programmable logic device (PLD), a field-programmable gate array (FPGA), a processor, a controller, a microcontroller, a microprocessor, an electronic unit designed to perform functions described herein, and a computer-readable medium, at least one of which is implemented. For software implementations, implementations such as processes or functions may be implemented with separate software modules that allow the execution of at least one function or operation. The software code may be implemented by a software application (or program) written in any suitable programming language, and the software code may be stored in memory and executed by the controller.

Accordingly, some embodiments of the present invention also provide an aerial survey system comprising a UAV as well as an aerial survey device 300 as described above. Referring to FIG. 4, the aerial survey device 300 may be a remote control device 100 as shown in FIG. 4.

The aerial survey device 300 is used to send to the UAV a planned and obtained photographing route for photographing a ribbon target.

The UAV is used to fly in accordance with the photographing route and during the flight to capture first images at first photographing waypoints of the first route and second images at second photographing waypoints of the second route using a photographing device.

In exemplary embodiments, there is also provided a non-transitory computer-readable storage medium including instructions, such as a memory including instructions, the instructions being executable by a processor of a device to accomplish the method. For example, the non-transitory computer-readable storage medium may be ROM, random access memory (RAM), CD-ROM, magnetic tape, floppy disks, and optical data storage devices, among others.

A non-transitory computer-readable storage medium that, when instructions in the storage medium are executed by a processor of a terminal, enables the terminal to perform the method described above.

It should be noted that, in this document, relational terms such as first and second are used only to distinguish one entity or operation from another, and do not necessarily require or imply the existence of any such actual relationship or order between those entities or operations. The terms “including”, “comprising”, or any other variant thereof, are intended to cover non-exclusive inclusion, so that a process, method, article or apparatus comprising a set of elements includes not only those elements, but also other elements that are not expressly enumerated, or that a process, method, article or apparatus comprising a set of elements for such a process, method, article or apparatus is also included. Or it also includes elements that are inherent to such process, method, article or apparatus. Without further limitation, the fact that an element is defined by the phrase “includes a . . . ” does not preclude the existence of another identical element in the process, method, article or apparatus that includes the element.

The methods and devices provided in the embodiments of the present invention are described in detail above, and specific examples are applied herein to illustrate the principles and implementations of the present invention, and the above illustrations of the embodiments are only used to assist in understanding the methods of the present invention and its core ideas; at the same time, for the general technical personnel in the field, based on the ideas of the present invention, there will be changes in the specific implementations and the scope of the application, which should not be construed as limiting the present invention. In summary, the contents of this specification should not be construed as a limitation of this application.

What is claimed is:

1. A method of route planning, comprising:
obtaining positional information of an target; and
based on the positional information of the target, planning a photographing route for photographing the target, the photographing route comprising a first route and a second route, an extension direction of the first route and an extension direction of the second route being substantially same as an extension direction of the target, a length of the first route being shorter than a length of the second route, and the first route comprising a first photographing waypoint, the second route comprising a second photographing waypoint; and
controlling a photographing device comprising a photosensitive structure photographs a first image at the first photographing waypoint and a second image at the second photographing waypoint, and
wherein a first orientation of projection of the photosensitive structure of the photographing device corresponding to the first image on a horizontal plane is different from a second orientation of projection of the photosensitive structure corresponding to the second image on the horizontal plane.

2. The method according to claim 1, wherein the first orientation of the projection of the photosensitive structure corresponding to the first image on the horizontal plane is opposite to the second orientation of the projection of the photosensitive structure corresponding to the second image on the horizontal plane.

3. The method according to claim 2, wherein the photographing device is mounted on a movable platform, a first heading direction of the movable platform when moving along the first route is opposite to a second heading direction of the movable platform when moving along the second route so that the orientation of the projection of the photosensitive structure corresponding to the first image on the horizontal plane is opposite to the orientation of the projection of the photosensitive structure corresponding to the second image on the horizontal plane.

4. The method according to claim 1, wherein a distance between two adjacent photographing waypoints in the first route is less than a distance between two adjacent photographing points in the second route.

5. The method according to claim 4, wherein first images captured by the photographing device at the two adjacent photographing waypoints in the first route satisfy a first overlapping rate;
second images captured by the photographing device at the two adjacent photographing waypoints in the second route satisfy a second overlapping rate; and
the first overlapping rate is greater than the second overlapping rate.

6. The method according to claim 1, wherein a first orientation of the photographing device when the photographing device is moved along the first route is different from a second orientation of the photographing device when the photographing device is moved along the second route.

7. The method according to claim 6, wherein a first angle between the first orientation of the photographing device and a direction of gravity when the photographing device is moved along the first route is different from a second angle between the second orientation of the photographing device and the direction of gravity when the photographing device is moved along the second route.

8. The method according to claim 1, wherein an orientation of the photographing device changes gradually as the photographing device is moved along the first route.

9. The method according to claim 8, wherein an angle value between the orientation of the photographing device and the direction of gravity becomes smaller and then larger when the photographing device is moved along the first route.

10. The method according to claim 1, wherein a ratio between the length of the first route and the length of the second route is greater than a predetermined ratio.

11. The method according to claim 1, wherein an end point of the first route is the same as a start point of the second route; or
the end point of the first route is different from the start point of the second route, the photographing route further comprises a third route comprising the end point of the first route and the start point of the second route.

12. The method according to claim 1, wherein an end point of the first route is different from a start point of the second route, the second route is located substantially directly above a centerline of the target, and the first route is located on one side of the second route.

13. The method according to claim 1, wherein the photographing device is mounted on a drone.

14. The method according to claim 1, wherein the target comprises a ribbon-shaped target.

15. A route planning device, comprising:
at least one processor; and
at least one memory including computer program code, where the at least one memory and the computer program code are configured, with the at least one processor, to cause the route planning device to at least:
obtain positional information of an target; and
based on the positional information of the target, plan a photographing route for photographing the target, the photographing route comprising a first route and a second route, an extension direction of the first route and an extension direction of the second route being substantially same as an extension direction of the target, and a length of the first route being shorter than a length of the second route, and
the first route comprising a first photographing waypoint, the second route comprising a second photographing waypoint; and
controlling a photographing device comprising a photosensitive structure photographs a first image at the first photographing waypoint and a second image at the second photographing waypoint, and
wherein a first orientation of projection of the photosensitive structure of the photographing device corresponding to the first image on a horizontal plane is different from a second orientation of projection of the photosensitive structure corresponding to the second image on the horizontal plane.

16. The route planning device according to claim 15, wherein the first orientation of the projection of the photosensitive structure corresponding to the first image on the horizontal plane is opposite to the second orientation of the projection of the photosensitive structure corresponding to the second image on the horizontal plane.

17. The route planning device according to claim 16, wherein a first orientation of the photographing device when moving along the first route is opposite to a second orientation of the photographing device when moving along the second route so that the orientation of the projection of the photosensitive structure corresponding to the first image on the horizontal plane is opposite to the orientation of the projection of the photosensitive structure corresponding to the second image on the horizontal plane.

18. The route planning device according to claim 15, wherein a distance between two adjacent photographing waypoints in the first route is less than a distance between two adjacent photographing points in the second route.

19. The route planning device according to claim 15, wherein an orientation of the photographing device changes gradually as the photographing device moves along the first route.

20. The route planning device according to claim 15, wherein an end point of the first route is the same as a start point of the second route; or
the end point of the first route is different from the start point of the second route, the photographing route further comprises a third route comprising the end point of the first route and the start point of the second route.
